(19) United States
(12) Patent Application Publication
(10) Pub. No.: US 2026/0029372 A1
(43) Pub. Date: Jan. 29, 2026

(54) ELECTROCHEMICAL SUGAR CONCENTRATION MEASUREMENT METHOD

(71) Applicant: LIGHTTELLS CORPORATION LIMITED, ZHUBEI CITY (TW)

(72) Inventors: BING-CHEN GU, HSINCHU COUNTY (TW); YU-HAN DAI, HSINCHU COUNTY (TW); YEN-ZHU LIN, HSINCHU COUNTY (TW); CHAO-CHIN CHIU, HSINCHU COUNTY (TW); BING-YU WANG, HSINCHU COUNTY (TW)

(73) Assignee: LIGHTTELLS CORPORATION LIMITED, ZHUBEI CITY (TW)

(21) Appl. No.: 19/247,072

(22) Filed: Jun. 24, 2025

(30) Foreign Application Priority Data
Jul. 26, 2024 (TW) 113127861

(51) Int. Cl. G01N 27/48

(52) U.S. Cl. CPC G01N 27/48

(57) ABSTRACT

An electrochemical sugar concentration measurement method includes: a test solution preparing step, combining a sugar-containing test sample with a copper sulfate-containing solvent to form a test solution; a testing step, in room temperature environment and without need for additional heating, dropping the test solution onto an electrode test strip and applying a driving voltage to the electrode test strip through electrochemical voltammetry to activate oxidation-reduction reaction of the test solution, and detecting a current value within a potential range of the electrode test strip to obtain a current value data; and an analyzing step, analyzing the current value data to obtain a sugar concentration data of the sugar-containing test sample. The present disclosure achieves the advantages of simple operation, high testing efficiency, and high measurement precision, and resolve industrial safety issues of conventional heating methods.

### BACKGROUND OF THE DISCLOSURE

### 1. Field of the Disclosure

The present disclosure relates to measurement methods, and more particularly, to an electrochemical sugar concentration measurement method.

### 2. Description of the Related Art

Various conventional sugar concentration measurement methods have been introduced in industry, such as the sugar concentration measurement methods (including those using refractometer or spectrophotometer) which measure sugar concentration based on optical principles (changes in absorption or refractive index of light), and Benedict's reagent-based test method relying on oxidation-reduction reactions.

Typically, the test solution used in optical detection methods must be produced by undergoing a reaction catalyzed by an enzyme. Also, during the testing process, absorption or refractive index of light may be affected by the color of the solution, leading to high operational difficulty and poor accuracy in current optical measurement methods.

Moreover, in Benedict's reagent-based test method, each testing step involves a heating process, and the sugar concentration is only approximately determined based on the color change thereof, resulting in low measurement precision and possible hazards during the heating process in current Benedict's reagent-based test method.

### SUMMARY OF THE DISCLOSURE

The present disclosure aims at resolving the issues of high operational difficulty and low accuracy of existing optical detection methods, as well as the low measurement precision and possible hazards during the heating process associated with current Benedict's reagent-based test methods.

For achieving the aforementioned objectives, the present disclosure provides electrochemical sugar concentration measurement method, comprising:
a test solution preparing step, combining a sugar-containing test sample with a copper sulfate-containing solvent to form a test solution;
a testing step, at room temperature and without need for additional heating, dropping the test solution onto an electrode test strip and applying a driving voltage to the electrode test strip through electrochemical voltammetry to activate an oxidation-reduction reaction of the test solution, and detecting a current value within a potential range of the electrode test strip to obtain a current value data; and
an analyzing step, analyzing the current value data to obtain a sugar concentration data of the sugar-containing test sample

With such method, the present disclosure enables the testing steps to be performed under room temperature conditions, without the need for a heating process, so as to effectively address the industrial safety issues associated with the heating procedure in conventional test methods.

Also, by carrying out the sugar concentration measurement through the electrochemical voltammetry, the present disclosure is able to measure the sugar concentration in the sugar-containing test sample in an extremely short time period. Therefore, the present disclosure achieves the advantages of simple operation, high testing efficiency, and high measurement precision.

### BRIEF DESCRIPTION OF THE DRAWINGS

FIG. 1 is a flow chart of the electrochemical sugar concentration measurement method in accordance with an embodiment of the present disclosure.

FIG. 2 is a flow chart of the electrochemical sugar concentration measurement method in accordance with another embodiment of the present disclosure.

FIG. 3 is a schematic view of the operation status of a flow chart of the electrochemical sugar concentration measurement method in accordance with an embodiment of the present disclosure, illustrating the test solution injected into the electrode test strip.

FIG. 4 is schematic view of a current curve in accordance with an embodiment of the present disclosure.

FIG. 5 is a schematic view illustrating the linear relationship between current and concentration in accordance with an embodiment of the present disclosure.

FIG. 6 is a schematic view illustrating the linear relationship between temperature and correction coefficient in accordance with an embodiment of the present disclosure.

FIG. 7 is a flow chart of the establishment method of the standard database in accordance with an embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

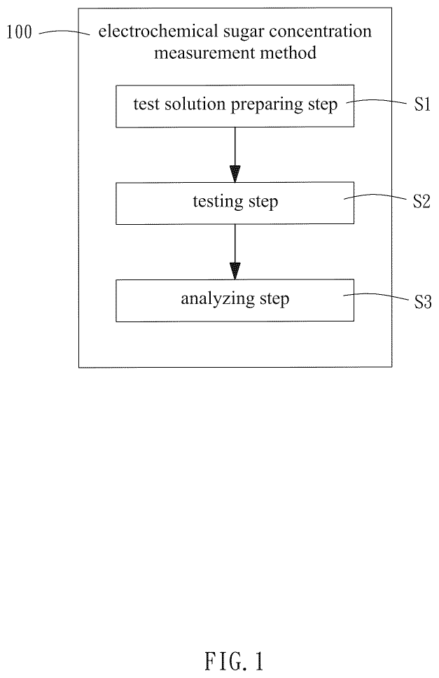

Referring to FIG. 1 to FIG. 7, the present disclosure provides an electrochemical sugar concentration measurement method 100, comprising a test solution preparing step S1, a testing step S2, and an analyzing step S3. The present disclosure is capable of measuring the sugar concentration in a sugar-containing liquid, particularly a low sugar concentration, such as those below 5%. The sugar in the sugar-containing liquid is allowed to be, for example but not limited to, monosaccharides, such as glucose and fructose; disaccharides, such as lactose, maltose, and sucrose; and polysaccharides, such as starch, so that all of the above are within the test range of the present disclosure.

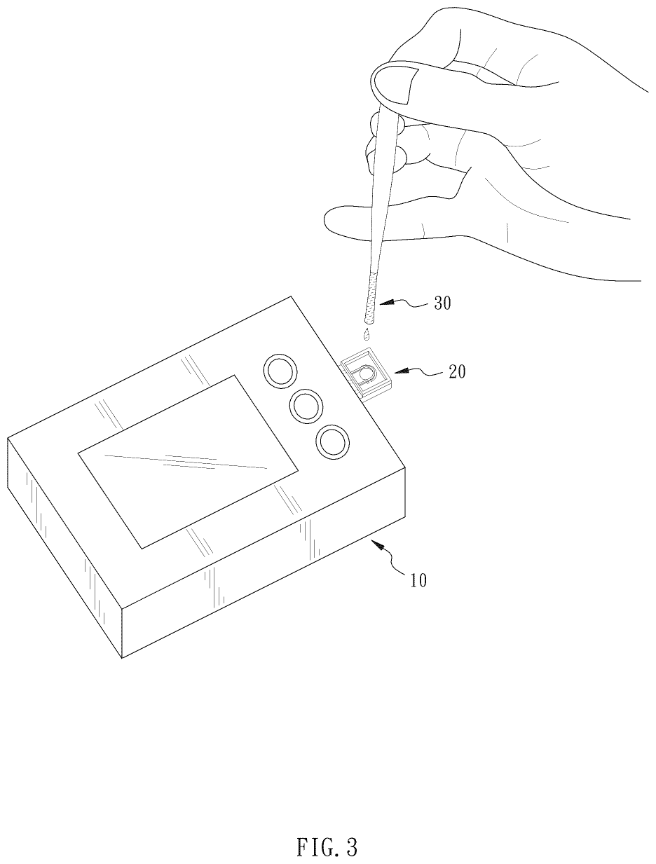

Referring to FIG. 1 and FIG. 3, the electrochemical sugar concentration measurement of the present disclosure is carried out through a testing device 10 in conjunction with an electrode test strip 20, so as to perform the sugar concentration measurement of a sugar-containing test solution 30. Therein, the test solution 30 is prepared through the test solution preparing step S1.

In the test solution preparing step S1, a sugar-containing sample is mixed with a copper sulfate-containing solvent to form the test solution 30. Therein, the volume of the sugar-containing sample ranges from 0.1 ml (milliliter) to 1 ml. By conducting such micro-volume testing, the cost of the mixture preparation is reduced. The copper sulfate concentration of the copper sulfate-containing solvent ranges from of 0.01 M to 1.5 M.

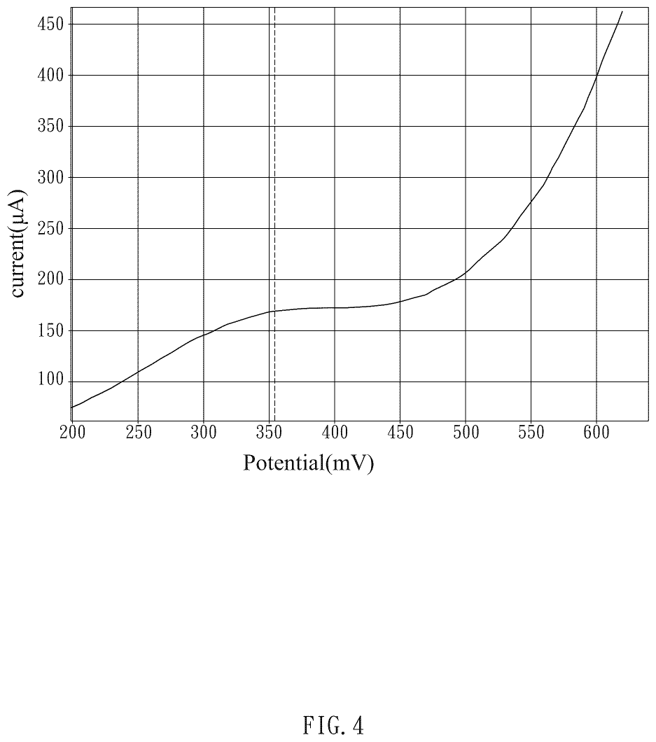

In the testing step S2, at the temperature in a room temperature environment and without the need for additional heating, the test solution 30 is dropped onto the electrode test strip 20, and a driving voltage is applied to the electrode test strip 20 through electrochemical voltammetry, so as to activate the oxidation-reduction reaction of the test solution 30, after which the electrode test strip 20 undergoes a current detection within a potential range, thereby obtaining a current value data (as shown by FIG. 4).

In the embodiment, the testing time of the electrochemical voltammetry is less than one minute. Therefore, the present disclosure is capable of measuring the sugar concentration of the sugar-containing sample in an extremely short time period, enhancing the testing efficiency. Therein, the electrochemical voltammetry is allowed to be linear voltammetry or pulse voltammetry.

Referring to FIG. 4, in the embodiment, the potential range is between 0 mV (millivolt) to 600 mV. Preferably, the potential range is between 300 mV to 450 mV, so that a more accurate current value data is obtained, thereby excluding the current value with excessive deviation.

In the embodiment, the room temperature ranges from 20 degrees Celsius to 35 degrees Celsius. Preferably, the room temperature ranges from 20 degrees Celsius to 25 degrees Celsius. Accordingly, the present disclosure abandons the conventional method that performs a heating process to activate the oxidation-reduction reaction, and instead uses electrochemical voltammetry to activate the oxidation-reduction reaction of the test solution 30, such that the operation of the testing step S2 is allowed to be carried out at room temperature (ranging from 20 degrees Celsius to 35 degrees Celsius), effectively resolving the industrial safety issues and the complexity of testing procedures associated with the conventional heating method.

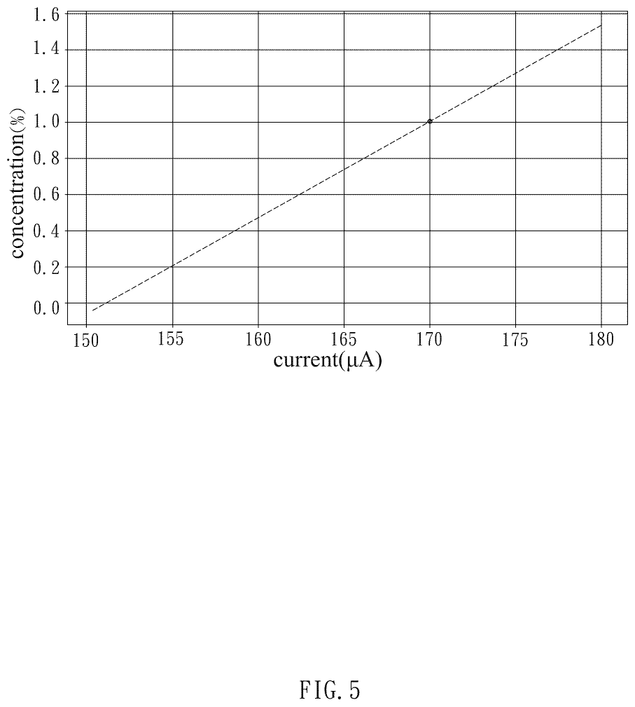

In the analyzing step S3, the current value data is analyzed to obtain a sugar concentration data of the sugar-containing sample. Therein, in the embodiment, the present disclosure compares the current value data with a standard sugar potential data stored in a standard database, thereby obtaining the sugar concentration data. For example, referring to FIG. 4 and FIG. 5, the present disclosure, based on the standard sugar potential data (i.e., the linear comparison chart of current and sugar concentration shown in FIG. 5), obtains the sugar concentration data corresponding to the current value data; that is, when the potential range is 375 mV and the current value is 170 microamps, the corresponding sugar concentration data is 1%.

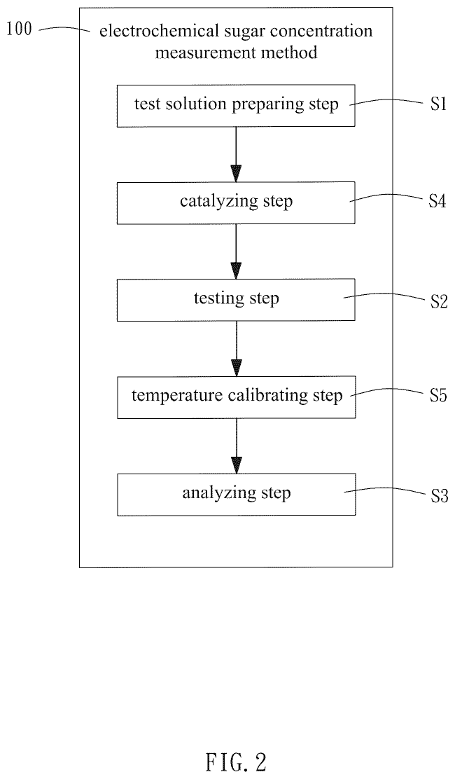

Referring to FIG. 2, when the sugar in the sugar-containing test sample is a disaccharide (such as sucrose) or a polysaccharide (such as starch), a catalyzing step S4 is allowed to be performed before the testing step S2. In the catalyzing step S4, a catalyzing voltage is applied to the test solution 30 to catalyze the hydrolysis of the disaccharide or polysaccharide, such that the disaccharide or the polysaccharide is hydrolyzed into monosaccharides. Accordingly, the present disclosure is able to determine the concentration of the disaccharide or the polysaccharide in the sugar-containing test sample by measuring the concentration of monosaccharides.

In the embodiment, the catalyzing voltage is a scanning voltage ranging from −1000 mV to 1000 mV, and the scanning rate of the catalyzing voltage ranges from 20 mV per second to 250 mV per second. Preferably, the scanning rate of the catalyzing voltage is 100 millivolts per second. Notably, if the scanning rate of the catalyzing voltage is lower than 20 mV per second, the catalyzing effect of the catalyzing voltage will be subject to significant reduction, resulting in incomplete hydrolysis of the disaccharides or the polysaccharides, thereby causing the subsequently analyzed sugar concentration data to be inaccurate; if the scanning rate of the catalyzing voltage exceeds 250 mV per second, which is beyond the load capacity of the electrode test strip 20, the electrode test strip 20 is prone to structural damage.

Referring to FIG. 2, in the testing step S2, when the operating temperature detected by a temperature detection device is higher or lower than the current room temperature set in the standard database, a temperature calibrating step S5 is first performed during the testing step S2, whereby the current value data is calibrated based on a potential temperature calibration data corresponding to the operating temperature in order to obtain a calibrated current value data.

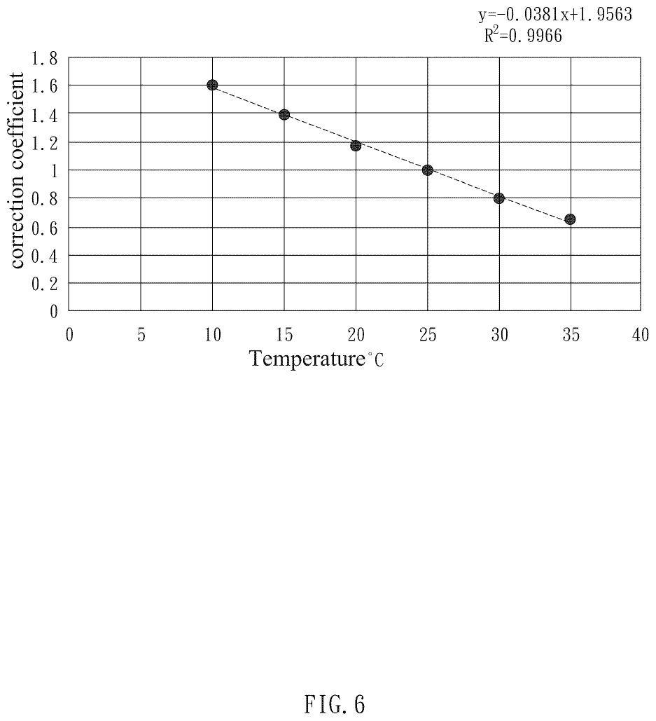

Therein, the current value data is multiplied by a correction coefficient corresponding to the operating temperature in the potential temperature calibration data, so as to obtain the calibrated current value data. Furthermore, if the operating temperature is higher than the temperature in the room temperature environment, the correction coefficient is less than 1 and greater than 0; if the operating temperature is lower than the room temperature, the correction coefficient is greater than 1. Accordingly, by calibrating the current value data with the correction coefficient, the present disclosure enhances the accuracy of the sugar concentration measurement. Referring to FIG. 6, for example, when the room temperature is set at 25 degrees Celsius, and the operating temperature (such as 30 degrees Celsius) is higher than the room temperature (25 degrees Celsius), the correction coefficient is 0.8; when the operating temperature (such as 10 degrees Celsius) is lower than the room temperature (25 degrees Celsius), the correction coefficient is 1.6.

Notably, the temperature calibrating step S5 is performed when the operating temperature is between a temperature range. For example, in the present disclosure, the temperature range is set to range from 10 degrees Celsius to 45 degrees Celsius. If the temperature detection device detects that the operating temperature is not within such temperature range, the operating temperature is determined to be abnormal, and a warning is sent to notify the user that the current environment is unsuitable for the testing operation.

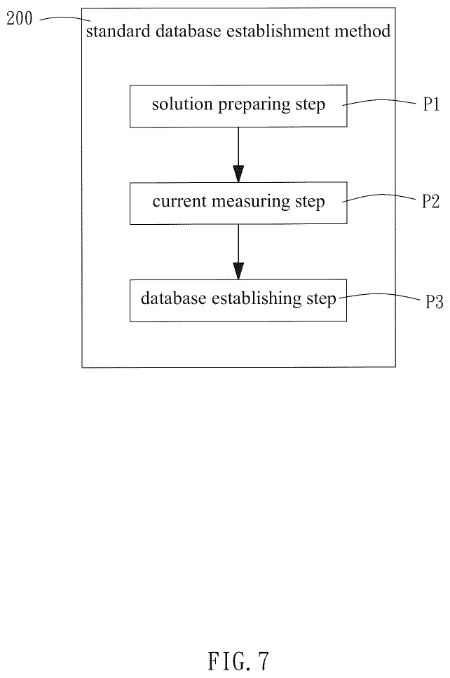

Referring to FIG. 7, the present disclosure further provides a standard database establishment method 200, comprising a solution preparing step P1, a current testing step P2, and a database establishing step P3.

In the solution preparing step P1, a plurality of sugar-containing samples having different sugar concentrations are respectively mixed with the copper sulfate-containing solvent to form a plurality of test solutions, and a known sugar concentration data of each sugar-containing sample is recorded.

In the current testing step P2, at the temperature in a room temperature environment and without the need for additional heating, each test solution is dropped onto the electrode test strip 20, and the driving voltage is applied to the electrode test strip 20 through electrochemical voltammetry, so as to activate the oxidation-reduction reaction of each test solution, after which the electrode test strip 20 undergoes the current detection within the potential range, thereby obtaining a corresponding current value data for each sugar-containing sample. Therein, the corresponding current value data comprises multiple current value curves, each of which corresponds to each known sugar concentration data.

In the database establishing step P3, the known sugar concentration data and the corresponding current value data are integrated into the standard sugar potential data, thereby establishing the standard database that stores the standard sugar potential data. Therein, referring to FIG. 5, the linearity between the current and the sugar concentration in the standard sugar potential data established by the present disclosure reaches as high as 0.9905, which indicates that the sugar concentration measurement performed by use of the present disclosure exhibits a considerably high accuracy. Also, user is allowed to store the standard database on a terminal device or a cloud server, facilitating convenient storage and maintenance of the standard database.

In addition, the potential temperature calibration data is also allowed to be stored in the standard database, allowing the user to maintain and update both the standard sugar potential data and the potential temperature calibration data via the standard database.

With the foregoing configuration, advantages of the present disclosure will be illustrated below.

The present disclosure is able to perform the testing step S2 at the room temperature without the need for a heating process, thereby effectively addressing the industrial safety issues associated with the heating procedure in conventional test methods.

By carrying out the sugar concentration measurement through the electrochemical voltammetry, the present disclosure is able to measure the sugar concentration in the sugar-containing test sample in an extremely short time period, achieving the advantages of simple operation, high testing efficiency, and high measurement precision.

The potential range in the present disclosure is set between 0 mV to 600 mV, preferably between 300 mV to 450 mV, so that a more accurate current value data is obtained, thereby excluding the current value with excessive deviation.

By catalyzing the hydrolysis of the test solution 30 through the catalyzing step S4, the present disclosure is applicable not only to monosaccharides but also to disaccharides and polysaccharides.

The present disclosure is able to calibrate the current value data using the correction coefficient, so as to maintain the measurement accuracy of the sugar concentration data under varying temperatures.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. An electrochemical sugar concentration measurement method, comprising:
a test solution preparing step, combining a sugar-containing test sample with a copper sulfate-containing solvent to form a test solution;
a testing step, in room temperature environment and without need for additional heating, dropping the test solution onto an electrode test strip and applying a driving voltage to the electrode test strip through electrochemical voltammetry to activate an oxidation-reduction reaction of the test solution, and detecting a current value within a potential range of the electrode test strip to obtain a current value data; and
an analyzing step, analyzing the current value data to obtain a sugar concentration data of the sugar-containing test sample.

2. The electrochemical sugar concentration measurement method of claim 1, wherein a volume of the sugar-containing sample ranges from 0.1 ml to 1 ml.

3. The electrochemical sugar concentration measurement method of claim 1, wherein a copper sulfate concentration of the copper sulfate-containing solvent ranges from of 0.01 M to 1.5 M.

4. The electrochemical sugar concentration measurement method of claim 1, wherein a testing time of the electrochemical voltammetry is less than one minute.

5. The electrochemical sugar concentration measurement method of claim 1, wherein the electrochemical voltammetry is allowed to be linear voltammetry or pulse voltammetry.

6. The electrochemical sugar concentration measurement method of claim 1, wherein the potential range is between 0 mV to 600 mV.

7. The electrochemical sugar concentration measurement method of claim 1, wherein the potential range is between 300 mV to 450 mV.

8. The electrochemical sugar concentration measurement method of claim 1, wherein a temperature of the room temperature environment ranges from 20 degrees Celsius to 35 degrees Celsius.

9. The electrochemical sugar concentration measurement method of claim 1, wherein when the sugar in the sugar-containing test sample is a disaccharide or a polysaccharide, a catalyzing step is performed before the testing step; in the catalyzing step, a catalyzing voltage is applied to the test solution to catalyze a hydrolysis of the disaccharide or polysaccharide.

10. The electrochemical sugar concentration measurement method of claim 1, wherein in the analyzing step, the current value data is compared with a standard sugar potential data stored in a standard database in order to obtain the sugar concentration data, wherein an establishing method of the standard database comprises following steps:
a solution preparing step, mixing a plurality of sugar-containing samples having different sugar concentrations with the copper sulfate-containing solvent, respectively, to form a plurality of test solutions, and recording a known sugar concentration data of each sugar-containing sample;
a current testing step, in the room temperature environment and without need for additional heating, dropping each of the test solutions onto the electrode test strip, and applying the driving voltage to the electrode test strip through electrochemical voltammetry, so as to activate the oxidation-reduction reaction of each test solution, and detecting the current value within the potential range of the electrode test strip to obtain a current value data of each of the sugar-containing samples;
a database establishing step, integrating the known sugar concentration data and the corresponding current value data are into the standard sugar potential data, thereby establishing the standard database that stores the standard sugar potential data.

11. The electrochemical sugar concentration measurement method of claim 10, wherein when an operating temperature of the testing step is higher or lower than a temperature in the current room temperature environment set in the standard database, a temperature calibrating step is performed, whereby the current value data is calibrated based on a potential temperature calibration data corresponding to the operating temperature in order to obtain a calibrated current value data.
